(19) United States
(12) Patent Application Publication
(10) Pub. No.: US 2008/0068921 A1
(43) Pub. Date: Mar. 20, 2008

(54) Utensils

(76) Inventor: Kristin Schanche, Oslo (NO)

Correspondence Address: MICHAEL MOLINS;MOLINS & CO., SUITE 5, LEVEL 6, 139 MACQUARIE ST, SYDNEY NSW, 2000, omitted

(21) Appl. No.: 11/521,436

(22) Filed: Sep. 15, 2006

(51) Int. Cl. A47J 43/10

(52) U.S. Cl. 366/129

(57) ABSTRACT

A range of kitchen utensils having soft polymer surrounding edges is described. These utensils have a body moulding and a softer edge moulding, and can be used with surfaces having TPFE or similar coatings without damaging the coatings.

### FIELD OF THE INVENTION

The invention pertains to kitchen utensils and more particularly to utensils with a moulded-on edge.

### BACKGROUND OF THE INVENTION

Kitchen utensils are preferred by consumers when they are comfortable in the hand and aesthetically pleasing. Because utensils may come in contact with Teflon® (TPFE) coatings it is also an advantage to provide a soft edge that will not scratch Teflon® of similar coatings. Further, even some polymer cooking tools lack the scraping efficiency of soft rubber implements.

### OBJECTS AND SUMMARY OF THE INVENTION

It is an object of the invention to provide a kitchen utensil with a continuous moulded-on polymer edge.

It is another object of the invention to provide a method of manufacture of the above referenced utensils.

Accordingly, there is provided a kitchen utensil having a main body. The body is characterised by a circumferential rim. A polymer edge is moulded onto the rim wherein the edge is softer than the body.

### BRIEF DESCRIPTION OF THE DRAWING FIGURES

In order that the invention be better understood reference is now made to the following drawing figures in which:

FIG. 1 is a plan view of a whisk made in accordance with the teachings of the present invention;

FIG. 2 is a cross section of the whisk depicted in FIG. 1;

FIG. 3 is a detailed plan view of the neck of the whisk depicted in FIGS. 1 and 2;

FIG. 4 is a cross section through the neck of a whisk;

FIG. 5 is a perspective view of a spatula and its rim;

FIG. 6 is an inverted perspective of the spatula depicted in FIG. 5 with the edge moulded in place;

FIG. 7 is a perspective view of a potato masher incorporating the teachings of the present invention.

### BEST MODE AND OTHER EMBODIMENTS OF THE INVENTION

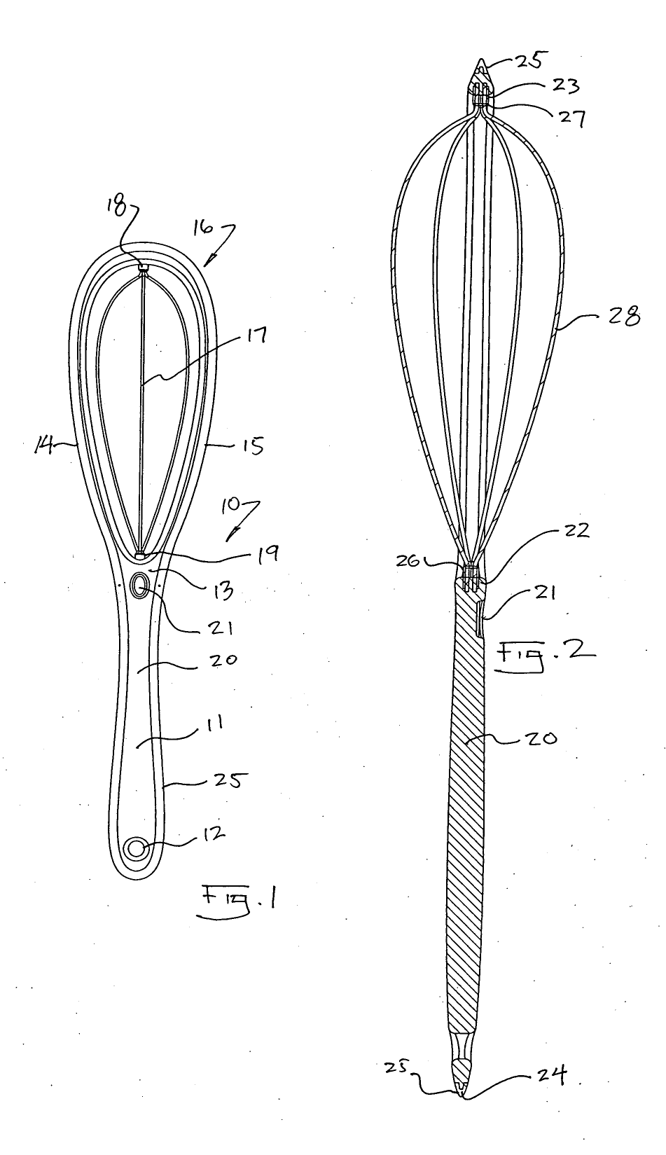

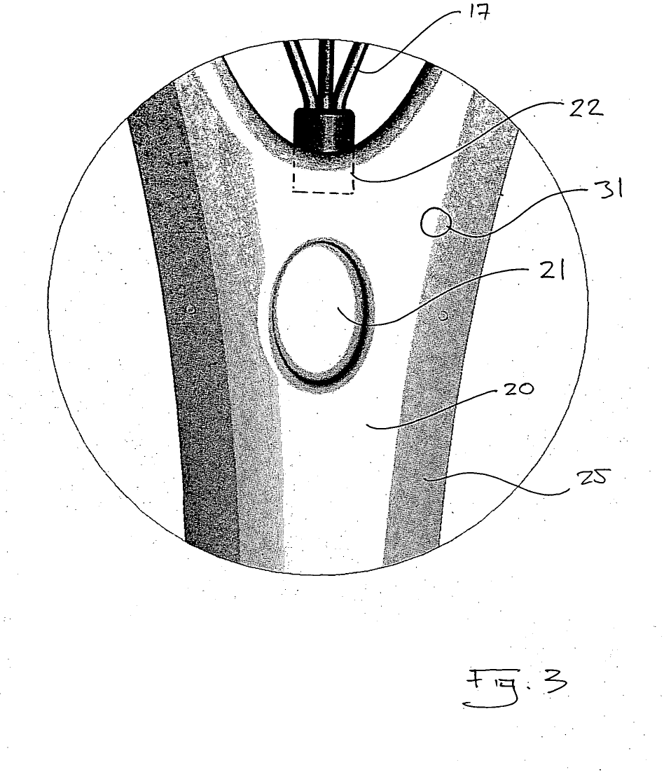

As shown in FIG. 1, a whisk 10 comprises a handle 11 having a through opening 12 at one end and a neck 13 at the other end. The neck 13 splits into two limbs 14, 15. The limbs 14, 15 form a continuous loop 16. The loop retains a metal wire assembly 17 that is held by the loop in two places 18, 19. As suggested by FIGS. 1 and 2, the main body of the whisk 10 comprises a unitary polymer moulding 20 that forms the structural basis of the handle, neck and loop. This moulding incorporates a dimple 21 or recess that in this example is located centrally in the neck region. The moulding 20 may also incorporate openings 22, 23 for receiving the metal wire assembly 17.

In preferred embodiments, the main body moulding 20 further comprises a circumferential rim 24 that completely surrounds the periphery of the main body moulding. This rim 24 serves to assist in the retention of a softer polymer edge 25 that is moulded-on or moulded in place after the main body is moulded. The softer polymer edge provides comfort and efficient scraping action. So that the main body can be located in and better retained by the second mould (that is used for the moulding-on of the edge 25) a dimple 21 with tapered side wall is provided. In some embodiments, the second mould may have features such as locator pins to cooperate with the dimple. In this example, only a single dimple 21 is illustrated. It will be understood that dimples may be provided in various locations and on either or both faces of the main body moulding 20. In some embodiments, the through opening 12 which is located at the distal end of the handle may also be used for locating the main body moulding in the second mould.

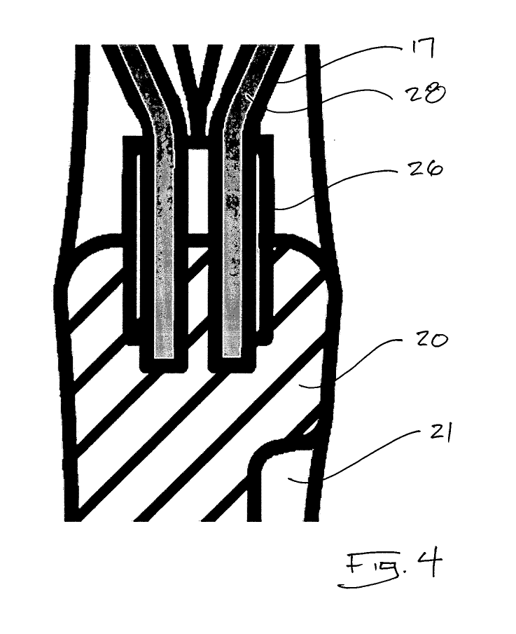

As shown in FIG. 2 the softer polymer edge 25 is approximately “A” shaped in cross section having legs to either side of an intermediate notch which receives the main body's rim 24. As suggested by FIG. 3, the second moulding is preferably flush in the area 31 where it joins the surfaces of the main body 20. This softer polymer may be a silicone polymer or another thermally stable injection mouldable polymer having a hardness of 40-50 Shore A.

As suggested by FIGS. 1-4, the metal wire assembly 17 further comprises a pair of metal cup-like hubs 26, 27 that each retains the ends of the longitudinal wires 28 that form the primary working components of the whisk. In preferred embodiments, each wire 28 is bowed between the pair of hubs 26, 27. As previously mentioned, the hubs 26-27 can be moulded into the primary body moulding 20 or can be inserted into openings 22, 23 that are formed into the body moulding before the hubs are inserted.

In this way, a whisk is formed having a harder and stiffer polymeric main body moulding is completely surrounded by a softer polymer edge. Because the edge is somewhat sharp (see FIG. 2) the edge is useful as a scraping tool while at the same time being incapable of scratching delicate surfaces such as PTFE surfaces. The addition of the softer polymer in the region of the handle also provides a comfortable grip for the user, the handle itself also forming a useful scraping tool with a different characteristic size than the loop area 16.

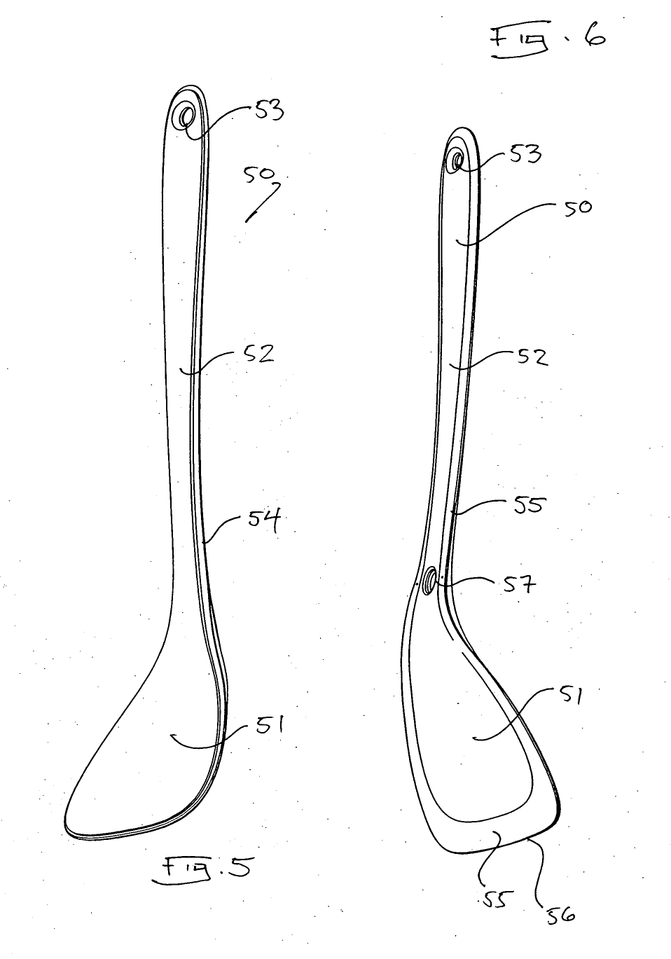

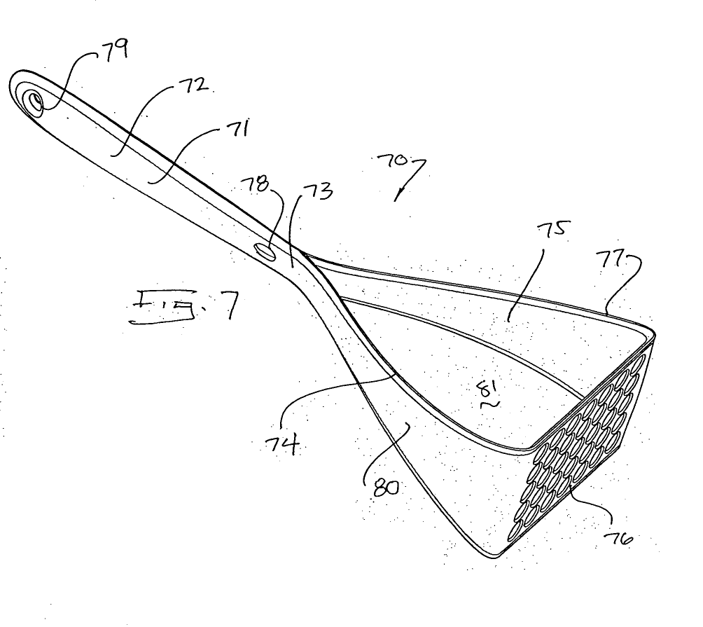

As shown in FIGS. 5 and 6, this same edge moulding technology may be applied to a spatula 50. In these examples, the spatula 50 comprises a flattened working surface 51 and an elongated handle 52. This integral main body moulding also has formed in it a through opening 53. The periphery of the main body moulding further comprises a raised rim 54 which like the examples depicted in FIGS. 1-4 is located approximately midway between the front and back surfaces of the utensil. As shown in FIG. 6, this rim 54 is used to locate and retain the moulded-on softer polymer edge 55 as previously described. The softer polymer edge provides a convenient grip as well as an ample non-scratching front edge 56 to the main work surface 51. Note the dimple 57 located in the neck area of the main body moulding between the handle 52 and the work surface 51.

Another example is depicted in FIG. 7. As illustrated, a potato masher 70 comprises an integral main body moulding 71 that forms a handle 72, a neck area 73 and a pair of interconnected limbs 80, 75 that both extend from the neck 73 and which are joined together by an integral working surface 76. In this example, the working surface 76 comprises a flat perforated area as is commonly associated with potato mashers. In this example, the edge moulding 77 forms a perimeter of the handle and splits in the area of the neck 73 so as to form two loops 74 that each extend around the opening 81 defined by the limbs and work surface. Thus, the edge moulding is continuous or uninterrupted along all of the free edges of the utensil. Also note that the locating dimple 78 is located in the area of the neck 73 but that it may be provided in other locations and that more than one dimple may be provided. This embodiment also exemplifies the use of the through opening 79 that is useful both as a way of hanging the tool after manufacture but that also may be used for location of the main integral body moulding in the second mould that is used for the moulding-on of the edge.

While the above embodiments have been provided with reference to particular details of construction, these should be understood as having been provided by way of example and not as limitations to the scope or spirit of the invention.

What is claimed is:

1. A kitchen utensil, comprising,
an integral main body moulding, the main body moulding further comprising a handle and a working portion;
the handle and the working portion sharing a common periphery a polymer edge moulding retained by the main body moulding and extending around the entire periphery.

2. The kitchen utensil in claim 1, wherein,
a circumferential rim completely surrounds the entire periphery.

3. The kitchen utensil in claim 2, wherein,
the edge moulding is moulded onto the rim.

4. The kitchen utensil in claim 3, wherein,
a cross section of the edge moulding is A-shaped, and has two legs, one to each side of an intermediate notch that receives the rim.

5. The kitchen utensil in claim 1, wherein,
the polymer edge moulding is softer than the main body moulding.

6. The kitchen utensil in claim 1, wherein,
the polymer edge moulding is flush in an area where it joins a surface of the main body moulding.

7. The kitchen utensil in claim 1, wherein,
the polymer edge is uninterrupted along all free edges of the utensil.

8. The kitchen utensil in claim 1, wherein,
there is at least one locating dimple located on the main body.

9. The kitchen utensil in claim 8, wherein,
one of the locating dimples is a through opening on the handle.

10. The kitchen utensil in claim 8, wherein,
the locating dimple is located in a neck between the handle and the working portion of the main body moulding.

11. A whisk, comprising,
an integral main body moulding, the body moulding further comprising a handle, a neck on a first end of the handle, the neck splitting into two limbs forming a continuous loop;
a metal wire assembly held by the loop and having longitudinal wires that form a primary working component of the whisk; and
the handle, neck and loop having a common periphery
a polymer edge moulding formed around the common periphery of the main body moulding.

12. The whisk in claim 11, wherein,
the main body moulding further comprises a circumferential rim that completely surrounds the common periphery.

13. The whisk in claim 12, wherein,
the loop further comprises two openings for receiving the metal wire assembly.

14. The whisk in claim 11, wherein,
the metal wire assembly further comprises a pair of metal cup-like hubs received by the openings, the hubs retaining the longitudinal wires.

15. The whisk in claim 14, wherein,
the longitudinal wires bow between the two metal hubs.

16. The whisk in claim 10, wherein,
a through opening is formed in a second end of the handle.

17. A method of manufacturing a kitchen utensil having a body moulding with a periphery and edge moulding, comprising the steps of:
forming the body moulding; and
injection moulding a polymer edge around the periphery;
the edge being softer than the body moulding;
the injection moulding of the edge occurring in a second mould.

18. The method in claim 17, wherein,
the body moulding is formed with one or more locating dimples that cooperate with features in the second mould.

19. The method in claim 17, wherein,
the periphery of the body moulding further comprises a rim that completely surrounds the first body moulding and assists in the retention of the polymer edge.

20. The method in claim 19, wherein,
a cross section of the polymer edge is A-shaped, and has two legs, one to each side of an intermediate notch receiving the rim.
